(19) United States
(12) Patent Application Publication
(10) Pub. No.: US 2011/0301399 A1
(43) Pub. Date: Dec. 8, 2011

(54) AQUEOUS WASTE DISPOSAL USING SUPERABSORBENT

(76) Inventor: Daniel Perlman, Arlington, MA (US)

(21) Appl. No.: 12/796,664

(22) Filed: Jun. 8, 2010

(51) Int. Cl. G21F 9/12; B65D 71/00; A62D 3/40; B09B 5/00; B09B 3/00; G21F 9/16

(52) U.S. Cl. 588/2; 588/252; 588/321; 588/255; 206/223

(57) ABSTRACT

A method for disposing of liquid aqueous laboratory waste is described, which involves solidifying the liquid waste with a suitable isovolumic, space-filling superabsorbent polymer within a disposable impermeable film-type container held in an open top, reusable rigid outer container such as a laboratory beaker, and closing and removing the disposable container containing the solidified waste from the rigid outer container. The waste held in the film-type container can be finally disposed of through incineration or deposit in a suitable landfill.

### RELATED APPLICATIONS

NOT APPLICABLE.

### FIELD OF THE INVENTION

The present invention relates to disposal of aqueous wastes in semi-solid form.

### BACKGROUND OF THE INVENTION

The following discussion is provided solely to assist the understanding of the reader, and does not constitute an admission that any of the information discussed or references cited constitute prior art to the present invention.

A variety of different absorbents have been used for absorbing water and other aqueous media. Such absorbents can be broadly categorized as fibrous absorbents, synthetic foam absorbents, particulate absorbents, and polymeric ionic absorbents.

Among the particulate absorbent media, clays and organoclays are often used. These materials absorb liquids through capillary action and interactions with surface moieties.

Fibrous (e.g., natural sponges and various cellulosic fiber absorbents) and open cell synthetic foam (e.g., polyurethane) absorbents absorb liquids primarily through capillary action in most cases. In many cases, these absorbents swell substantially upon water absorption, and generally have limited absorption capacity, typically absorbing only about 20 times or less their weight of water. In addition, they typically release substantial amounts of water under only light pressure.

Particular absorbents such as clays (e.g., various zeolites) generally absorb water through a combination of capillary action and polar interactions, e.g., with OH groups in the clay structure. However, a substantial amount of the retain water is simply interstitial water which does not substantially interact with the particles and which is therefore subject to draining from the absorbent under relatively low accelerating forces, and the absorption capacity is limited due to the rigid structure of the clays.

In contrast, superabsorbent polymer absorbents take up extremely high levels of water relative to the mass of the absorbent (e.g., often 300-1000 times by weight). The water is strongly retained through extensive hydrogen bonding between the water and the absorbent. In many cases, the absorbent carries extensive charged groups, most often anionic, and are provided as the corresponding salts, usually sodium or potassium salts, although other salts are also sometimes used. Superabsorbent polymers have been used, for example, for personal disposable sanitary products, soil moisture retention materials, and spill clean-up materials. Two additional applications are described in the patents below.

Dandren et al., Flushable Toddler Toilet Chair Liner, U.S. Pat. No. 6,738,991, describes a potty chair liner which is stated to have “an impermeable outer liner, a permeable inner liner, and an absorbent core therebetween. The outer layer includes a closed bottom and a continuous side wall having a lip for positioning the container on the toddler toilet chair and defining an open top. The outer layer is formed of a soluble material such as polyvinyl alcohol coated with a polymeric film having hydrolytic degradability additives that allow the soluble material to dissolve only when the film is exposed to an excess of water and is thus degraded. The absorbent core includes polyacrylate crystals and cellulosic fibers.”

Tanhehco, Solidifier for a Liquid, U.S. Pat. No. 6,797,857 describes a solidifier which is “particularly useful in medical applications for converting waste (infectious) medical liquids or semi-liquids to a substantially non-pourable state for ready handling and disposal”. The solidifier includes multiple superabsorbents having different densities, such that some float and some sink. To use the solidifier, a disintegrating absorbent packet within a closed rigid container is described, where the packet disintegrates when it is contacted by liquid medical waste placed into the closed rigid container.

### SUMMARY OF THE INVENTION

Disposal of aqueous laboratory and some other aqueous wastes is a continuing problem due to the types and levels of contaminants often found in the waste. Frequently, laboratory wastes are contaminated with chemicals for which skin contact and/or accidental release into the general laboratory environment should or must be avoided, making the wastes substantially biologically and/or chemically hazardous. As a result, the wastes often cannot or should not be directed into the usual drains to the normal waste water treatment facilities, and it is important to prevent release of the liquid on laboratory benchtops and floors. Also often it is necessary to highly desirable to prevent skin contact during the disposal process. Thus, special handling is required.

The method for special handling which is the subject of this invention is to convert the liquid aqueous waste into a solid or semi-solid for disposal into an acceptable landfill or for suitable incineration, and to carry out that conversion and disposal in a manner which is both convenient and designed to avoid spills. This invention addresses the disposal difficulty by providing a convenient conversion and handling method which provides substantially constant volume absorption (“isovolumic” absorption and conversion) using a free-swelling polyacrylate superabsorbent or similar acting superabsorbent material within a removable film-type disposable container that minimizes the amount of solid waste material contributed by the container while minimizing the risk of spillage, leakage or overflow of waste material during such isovolumic conversion. In particular, use of an absorbent which increases the combined volume of liquid aqueous waste and absorbent, even if only temporarily, presents a much higher risk of spillage of the waste—a risk which is minimized by the superabsorbent selection described herein. The absorbent properties and container size and configuration allow safe and convenient manual handling of the potentially hazardous waste. Furthermore, the free-swelling character of a suitable superabsorbent is important because it allows proper absorption to take place without requiring the superabsorbent particles to be agitated, such as by forceful waste liquid stream or by mechanical mixing.

Thus, a first aspect of the invention provides a method for disposing of liquid aqueous waste (usually liquid aqueous laboratory waste) as solidified waste. The method involves combining a volume of aqueous laboratory waste with a quantity of free-swelling, isovolumic superabsorbent sufficient to absorb the waste volume, thereby converting the aqueous waste to a solidified waste. The combining is performed in a disposable, impermeable, non-degrading film-type inner container held within and/or supported by a substantially rigid outer container, where the film-type inner container and rigid outer container each have substantially open tops. The rigid outer container is highly preferably watertight and chemically resistant to liquid laboratory waste that might accidentally leak through the inner film-type container. The method further involves closing the inner film-type container (e.g., using twist tie, adhesive closure, or zip-lock type closures), and lifting the film-type inner container containing the solidified waste from the outer container, highly preferably the lifting is manual lifting. As described below, the free-swelling characteristic of suitable superabsorbents means that additional agitation of the combined waste and superabsorbent is not needed to obtain effective absorption, e.g., agitation caused by rapid inflow of liquid aqueous waste.

In certain embodiments, the free-swelling, isovolumic superabsorbent is sodium polyacrylate or potassium polyacrylate or a mixture thereof; the superabsorbent is in the form of particles which sink in water (indicating their intrinsic density is greater than water, i.e., 1.00 g/ml); the superabsorbent has an apparent density, i.e., bulk density (density of material including air spaces), or apparent specific gravity of approximately 0.5 to 0.75 g/ml, 0.5 to 0.65 g/ml, 0.6 to 0.75 g/ml, or 0.68 to 0.72 g/ml; a plurality of separate additions of aqueous waste and superabsorbent particles is performed without formation of a floating cap on the surface of the aqueous waste; the particles of superabsorbent having an intrinsic density greater than that of aqueous waste, swell upon contact with the waste, substantially beginning from the bottom of the disposable inner container, thereby preventing the superabsorbent from forming a floating cap on the surface of the aqueous waste, and allowing a plurality of further additions of laboratory waste and superabsorbent to be made prior to removal of the disposable inner container.

In certain embodiments, the aqueous waste (usually laboratory waste) contains a polar organic solvent distributed throughout an aqueous phase with no separate organic solvent phase; the aqueous waste contains a ketone, an alcohol, and or an aldehyde, for example at up to 5, 10, 15, 20, 25, by weight or even more; the aqueous waste contains acetone or ethanol or both, for example, at up to 5, 10, 15, or 20 percent or even more by weight, and may contain one or more other water-miscible solvents, for example other ketones, alcohols, and/or aldehydes; the aqueous waste (usually laboratory waste) is contaminated with a water-miscible organic solvent, a metal, a radioactive isotope, or a combination thereof.

In some embodiments, the method involves a plurality of separate additions of aqueous waste (usually laboratory waste) and superabsorbent prior to removal of the film-type inner container.

In particular embodiments, the method includes incinerating the film-type inner container and solidified waste (usually solidified laboratory waste) in an approved incinerator; the method includes disposing of the film-type inner container and solidified waste in an approved solid waste landfill; the solidified waste satisfies regulatory requirements for transport and disposal as solid waste.

The method is particularly well adapted for volumes commonly encountered in individual laboratories. Thus, in advantageous embodiments, the film-type container has a capacity of 0.5 to 4 liters, 0.5 to 2 liters, or 2 to 4 liters; the film-type container is formed of low density polyethylene, high density polyethylene, polypropylene, polycarbonate, polyester; the rigid outer container is sized to fit a film-type inner container which has a capacity of 0.5 to 4 liters, 0.5 to 2 liters, or 2 to 4 liters; the rigid outer container has a capacity of 0.5 to 4 liters, 0.5 to 2 liters, or 2 to 4 liters (measured as the liquid capacity when the container is maximally filled).

A related aspect of the invention provides a kit for converting aqueous liquid laboratory waste to solidified waste. The kit includes at least 10 film-type inner containers of a size designed to be suitable for use in a pre-defined outer rigid container, and a sealed container of isovolumic superabsorbent (highly preferably free-swelling superabsorbent) sufficient for at least 10, 20, 30, or 50 of the film-type inner containers.

In particular embodiments, the film-type inner containers each have a capacity of 0.5 to 4, 0.5 to 2, or 2 to 4 liters.

Also in certain embodiments, the superabsorbent polymer preparation or the film-type inner container, or both are as specified for the aspect (and embodiments thereof) above.

Additional embodiments will be apparent from the Detailed Description and from the claims.

### BRIEF DESCRIPTION OF THE DRAWINGS

FIG. 1 is a process flow diagram showing the use of the present invention to convert aqueous waste into gel-like particles, all contained within a film-type container (also referred to as an inner liner) placed within, and held and supported by a rigid, leak proof outer container such as a laboratory beaker. Once the aqueous waste is solidified, the film-type container holding the gel-like particles is removed from the rigid outer container.

### DETAILED DESCRIPTION OF THE PREFERRED EMBODIMENTS

The present invention addresses the difficulties of disposing of contaminated aqueous wastes, especially from sources such as laboratories. Such aqueous wastes may contain a variety of contaminants, including dissolved salts of metals, radioactive isotopes, and low or moderate levels of polar organic solvents, among others. It is undesirable, and in some cases illegal, to dispose of such wastes through the usual water drain systems into conventional water treatment facilities. The present invention presents an alternative disposal method in which the aqueous wastes are solidified, such that handling is simplified and the solidified waste can be handled and disposed of as a solid rather than as a liquid. The devices and materials useful for this invention are selected to provide convenient manual lifting (and generally manual handling) of the solidified aqueous waste.

In this invention it was found that when certain superabsorbent materials, e.g., sodium polyacrylate superabsorbent, are placed in water (or aqueous waste), the compliant gel-like granules (i.e., the solidified aqueous material), which swell as the water is fully absorbed, collectively have substantially the same volume as the combination of water and dry absorbent. This means the absorbent can be used within a plastic film type container (i.e., a bag container) confined within a rigid leak-proof outer container, without risk of excessive swelling causing liquid or gel overflow from the bag, or of swelling causing wedging of the bag within the outer container. In addition, the superabsorbent materials found suitable are free-swelling, such that no additional agitation of the waste is needed to obtain rapid, effective absorption of the waste (e.g., agitation created by forceful inflow of the liquid waste and/or by mechanical stirring). That is, no mass is formed (e.g., on at the top or bottom of the liquid waste) which substantially interferes with rapid, effective absorption.

Thus, advantageously the aqueous waste absorption is carried out in a film-type inner container (e.g., a plastic bag) within an open-top rigid outer container. The film-type container should be impervious to water and should not degrade or dissolve under prolonged contact with the water or the usual aqueous laboratory wastes. In many cases, a plastic film of 1-8 mil thickness, often 2-6 mil, 2-5 mil or 3-4 mil thickness will be advantageous, e.g., sufficiently flexible to conform to the rigid outer container while being sufficiently strong to resist tearing or puncture under normal use and especially under manual lifting. Advantageously, there can be provision for closing and/or sealing the container opening, e.g., twist ties, adhesive tape sealer, or zip-type closure.

The film-type containers may be made of any of a number of different solvent-resistant and corrosive chemical-resistant materials. Non-limiting examples include polyethylene (low density polyethylene (LDPE) or high density polyethylene (HDPE)), polypropylene, polyester, and polycarbonate.

The rigid container should have a top opening which is the same size or larger than any point below the top opening. Such a container may, for example, be a beaker having essentially cylindrical walls or a container having walls which slightly diverge from the bottom to the top opening, such as a small pail. Other similar containers may also be used. Such shapes allow for easy removal of the film-type container after it has been filled (or partially filled) with the gel formed by aqueous waste and absorbent. Thus, highly preferably, the rigid container has a bottom surface attached to substantially smooth sides, with an upper opening which is at least as large as any cross-sectional area below the upper opening, and highly preferably also without any protrusions or other structural features in the side walls which would interfere with removal of the filled film-type inner container.

For use of the current invention, a suitable rigid outer container is selected, along with a flexible (i.e., shape-compliant) film-type inner container sized to appropriately fit the rigid container. That is, the film-type container is preferably sized such that it will fill the cross-sectional area of the rigid container and has sufficient depth that the open end of the film-type container can extend past and be folded around the upper edge of the rigid container. With the film-type container in place within the rigid container, aqueous waste can be placed (e.g., poured) in the film-type container. Either before or after placement of the aqueous waste in the film-type container, the absorbent (e.g., a polyacrylate absorbent) is placed within the film-type container. The absorbent absorbs the aqueous waste, converting it into a gel-like consistency (usually in the form of gel-like particles).

Thus, the present invention provides a convenient, rapid, and low waste method for converting aqueous waste to a solid, thereby allowing for subsequent handling and final disposal of the liquid aqueous waste as a solid instead of as a liquid. While Tanhehco, U.S. Pat. No. 6,797,857 (incorporated herein by reference in its entirety) is concerned with maximizing the speed of liquid waste solidification by using a combination of superabsorbents having different densities, it does not address the challenge of allowing a plurality of additions of fluid laboratory waste and superabsorbent, and accomplishing a plurality of solidifications prior to removal of the film-type inner container, e.g., plastic film liner. Similarly, while Tanhehco utilizes a closed or semi-closed container for solidifying waste, use of that container system does not minimize the amount of waste in the form of container packaging material that is discarded along with the solidified liquid waste, nor does it operate or need to operate within the constraint of maintaining essentially constant waste volume within the vessel holding the liquid. Consequently, the present invention provides a highly advantageous method and system, which is particularly advantageous for disposal of aqueous laboratory wastes and allows the liquid to solid conversion to be performed using any waste volume up to the container capacity, in either a single or multiple separate waste solidifications.

### Superabsorbent Selection

Absorbents useful in this invention are generally superabsorbent polymers (SAP), a term which refers to polymers that can absorb and retain extremely large amounts of a liquid relative to their own mass. Such water absorbing polymers absorb aqueous solutions through hydrogen bonding between the polymer and the water molecules. As a result, the water-absorbing capacity of an SAP is affected by the ionic concentration of an aqueous solution. For example, an SAP may absorb 300-500 times its weight or even more of distilled water, but only about 50 times it weight of 0.9% saline solution.

The total absorbency as well as the swelling capacity is also a factor of the degree of cross-linking of the polymer. Lower density cross-linking generally results in higher absorbent capacity and a greater degree of swelling, but also exhibit a softer and more cohesive gel formation. On the other hand, higher cross-linking levels generally result in lower absorbent capacity and swelling, but with stronger resulting gels, which can maintain particle shape even when subjected to pressure.

A superabsorbent selected for use in this invention should absorb water in a substantially constant volume (i.e., isovolumic) manner. That is, the total volume of water plus dry absorbent is essentially the same as the volume of the resulting gel-like material after the water has been absorbed. As part of this constant volume property, the swollen absorbent granules should form a compliant and space-filling granular mass, without air spaces being formed either within the swelling granules or between the granules (interstitial air spaces) as the granules swell within a volume of liquid. While being compliant and space filling, the swollen particles should have sufficient strength (resulting, for example, from a suitable level of cross-linking) to prevent the gel particles from breaking down and/or releasing liquid such that a liquid behavior rather than semi-solid behavior is produced upon normal handling.

In addition, the dry absorbent material is non-buoyant, that is, the particles will sink upon placement in water. This implies the absorbent particles prior to swelling have intrinsic densities greater than 1.0 g/cm³. It should be noted that typically apparent densities or apparent specific gravities are reported for these materials, where reference to “apparent” means that the reported density includes air spaces within the collection of particles. Suitable particles have been found which have apparent densities (or apparent specific gravities) which are about 0.5 or higher, e.g., in a range of about 0.50 to 0.75 g/cm³, often about 0.60 to 0.75 g/ml, 0.65 to 0.75 g/ml, or 0.68 to 0.72 g/cm³. In addition, the swollen absorbent should also preferably have an intrinsic density greater than that aqueous waste which is absorbed. In most cases, this will mean the swollen superabsorbent has a density greater than that of water, i.e., greater than 1.0 g/cm³, so that the swollen polymer particles sink rather than forming a mass or cap at the surface of the waste liquid. Still further, the superabsorbent particles are free-swelling, not requiring stirring or other additional agitation to obtain rapid effective swelling. Highly advantageously, this typically this further means the absorbent are substantially non-clumping. That is, the dry particles should disperse in water sufficiently that they do not form a clump on the bottom of the container which prevents adequate absorption by buried particles.

While sodium polyacrylate is used in many cases, other superabsorbent polymers which satisfy the constant volume property and the density properties just described above can be used in this invention. Other superabsorbent polymers include, for example, potassium polyacrylate, polyacrylamide copolymer, ethylene maleic anhydride copolymer, cross-linked carboxy-methyl-cellulose, polyvinyl alcohol copolymers, cross-linked polyethylene oxide, and starch grafted copolymer of polyacrylonitrile, among others.

In an example of absorption tests using a suitable absorbent, the following results were observed using a sodium polyacrylate absorbent, BASF's Luquasorb® 1255, that is commercially provided as a granular powder having a particle size range of between approximately 0.15 mm and 0.6 mm for absorption tests performed at room temperature:
1. Into plain water, the granules solidified 200-300× their weight of water in approx 2 minutes
2. Into 1% by weight salt (NaCl)-containing water, the granules solidified 30-35× their weight of solution in approx 2 min.
3. Into 2% by weight salt (NaCl)-containing water, the granules solidified 20-25× their weight of solution in approx 3 min.
4. Into 20% by weight ethanol: 80% water, the granules solidified 100× their weight of solution in approx 3 min.
5. Into 20% by weight acetone: 80% water, the granules solidified 100× their weight of solution in approx 3 min.

As shown by the results in the test above, the absorbent is highly effective in absorbing water, water containing moderate levels of salt, and water containing substantial levels of miscible organic solvent.

Among a number of others, examples of other superabsorbent polymers which may be suitable include BASF Luquasorb® 1010, 1030, 1160, 1161, 1245, and 1280. These, as well as other superabsorbent polymer products from the same and other manufacturers can be readily evaluated to determine whether they satisfy the parameters described above for particles useful in the present invention in a particular application.

### Process and Kits

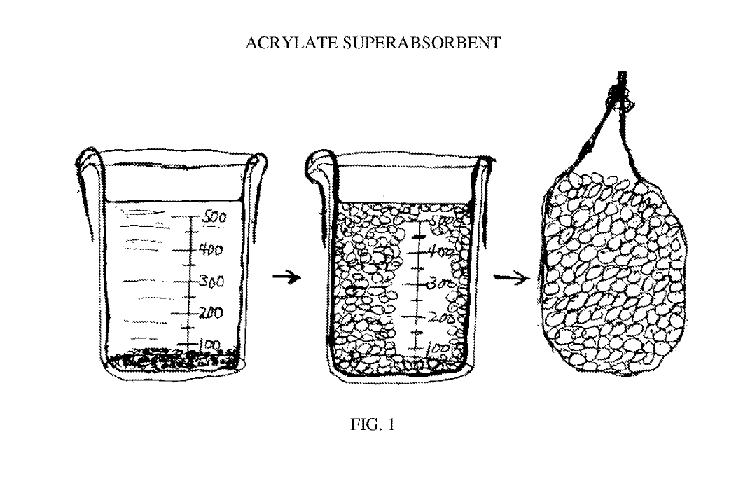

For clarity, a simple flow diagram illustrating the practice of the invention is shown in FIG. 1. As illustrated, a removable and disposable, impermeable film-type inner container 1 (i.e., a bag-type liner) is placed within a rigid outer container 2, with the upper open end 3 of the inner container wrapped over the upper edge(s) 4 of the rigid outer container. The resulting combined containers have an open top 5 allowing liquid waste and solid absorbent to be easily placed into the combined containers. Thus, in use aqueous waste 6 is placed into the combined containers. Either before or after addition of the aqueous waste, superabsorbent 7 is added, and isovolumic absorption of the aqueous waste by the superabsorbent takes place. In most cases, the superabsorbent is added after the waste, and sinks to the bottom of the combined container, absorbing the aqueous waste; usually a large majority of the absorption occurs after the superabsorbent particles have sunk. The result is a mass of compliant, swollen superabsorbent particles 8. Notably, the total volume of aqueous waste plus absorbent does not significantly change as the absorption of the aqueous waste occurs. As a result, the upper surface 9 of the aqueous waste plus superabsorbent remains at substantially the same level. At any time following addition of aqueous waste and superabsorbent (but usually after the absorption is at least substantially complete), the removable liner containing the swollen superabsorbent (e.g., the disposable filled container 10) is removed by hand from the rigid outer container for subsequent final disposal. As illustrated, the disposable filled container will distort in shape as it is removed due to the flexible nature of the film-type inner container and the compliant property of the swollen superabsorbent particles. The rigid outer container is constructed such that there are no constrictions, protrusions, cavities, or other structures in the rigid container which interfere with removal of the removable liner.

Most often, in practice, a volume of aqueous waste is placed within the film-type inner container, and a quantity of superabsorbent selected to be sufficient to absorb and solidify that waste volume is added. In most instances about 1% by weight of superabsorbent will be sufficient to create solidified waste. If firmer solidified waste is desired or required, an increased amount of superabsorbent can be added, e.g., about 1.5, 2, 2.5 or 3% by weight. Adjustments (typically increases) in the amount of superabsorbent added may also be readily made in cases where the liquid aqueous waste includes a significant concentration of charged species, especially dissolved salts.

For practical application of this invention, it is advantageous to provide a kit for disposal of liquid aqueous laboratory waste. Highly preferably, the kit components are packaged together, e.g., within a box or other shipping package. Such a kit may, for example, include a water-proof container of free-swelling, isovolumic superabsorbent, e.g., a substantially rigid container holding about 0.1-0.3, 0.3-0.5, 0.5-0.7, or 0.7 to 1.0 kg, or about 0.5-1.0, 0.8-1.5, or 1.0 to 2.0 lbs, along with a number of film-type containers (e.g., plastic bags) selected to hold up to a pre-selected volume (or sized to fit a pre-selected rigid container size. In many cases, the kit will include at least 10, 15, 20, 30, 40, or 50 such film-type containers. Also, a scoop for transferring the superabsorbent can advantageously be included in the kit, e.g., a polypropylene round bottom scoop, which may, for example, have a scoop volume of about 10, 12, 15, or 20 cm³, or sized to contain about 5, 7, 10, 12, 15, or 18 grams (e.g., ±2 grams) of dry superabsorbent. In many cases, the scoop will be provided within the waterproof container of superabsorbent.

### DEFINITIONS

As used herein in connection with uptake and retention of water by a material, the terms “absorption” and “absorbent” are used broadly to include all mechanisms whereby water is taken up and retained within the microstructure of a material. The terms include the technical definitions of absorption and adsorption, and include water uptake and retention through various mechanisms, e.g., capillary action, polar and charge interactions between the absorbent and water, and H-bonding between the water and the absorbent.

As used in connection with the present invention, the terms “constant volume”, and “isovolemic”, “isovolumic”, and “isovolumetric” are used equivalently and refer to an unchanged volume comparing the beginning and end of absorption of water or aqueous waste by the absorbent, where unchanged means no more than 5% volume change, and preferably no more than 4, 3, 2, or 1% volume change for the added volume of water plus absorbent.

The term “superabsorbent” refers to an absorbent material which absorbs at least 10 times its volume of distilled water, and preferably at least 15, 20, or even 30 times its volume, or at least 50 times its weight, preferably at least 100, 200, 300, 400 or more times its weight.

As used herein in connection with superabsorbent, the term “free-swelling” means that the superabsorbent will swell effectively without additional mixing or other agitation. That is, when the superabsorbent is placed in an amount of water within the volume range appropriate to this invention and which is sufficient to swell the quantify of superabsorbent, the superabsorbent will swell effectively without forming an unswollen or partially swollen mass, e.g., at the top or bottom of the container.

In reference to the film-type containers for use in this invention, the term “capacity” refers to the volume of swollen absorbent particles which will fit within the container while allowing the container to be securely closed using the closure method intended for use in this invention with the selected container.

As used in the context of additions of aqueous waste and superabsorbent in the containers, reference to “separate additions” means that superabsorbent is combined with liquid aqueous waste in discrete additions such that absorption of the liquid aqueous waste by the absorbent is substantially complete, or at least a majority of the absorption has occurred, before the next addition. Separate additions will commonly occur in one of two ways. First, the amount of superabsorbent initially added for a volume of aqueous waste may be insufficient to fully absorb the waste. In this case, a separate addition of superabsorbent may be done to complete the absorption. Second, liquid aqueous waste and superabsorbent may be placed in the container and absorption takes place. At some later time, a separate volume of aqueous waste and another quantity of superabsorbent may be added to the container and absorption of the new volume occurs. Additional such separate additions and absorptions may take place, until the practical (i.e., working) capacity of the film-type inner is reached.

Indication that the inner film-type container contributes a “minimal amount of additional solid waste” means that the container weight is only a very small fraction of the weight of the solidified waste it contains, typically not more than 1.5%, and most often not more than 1.0% or even less, e.g., not more than 0.7, 0.5, 0.3, or even 0.2%.

The term “manually lifting” refers to lifting by hand without the need for mechanical lifting aid, especially mechanical aid to handle excessive weight.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the particular superabsorbent used. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

What is claimed is:

1. A method for disposing of liquid aqueous laboratory waste as solidified waste, comprising
combining a volume of aqueous laboratory waste with an isovolumic, free-swelling superabsorbent whose intrinsic density is greater than that of said waste, and which is present in a quantity sufficient to absorb said volume thereby converting said aqueous laboratory waste to a solidified waste, wherein said combining is performed in a disposable, impermeable, film-type inner container contributing a minimal amount of additional solid waste, and that is held within and supported by a substantially rigid reusable outer container, wherein said disposable inner container and rigid outer container each have substantially open tops;
closing said inner film-type container; and
manually lifting said film-type inner container containing said solid waste from said outer container.

2. The method of claim 1, wherein a plurality of separate additions of said laboratory waste and superabsorbent are performed prior to removal of said film-type inner container.

3. The method of claim 1, wherein said isovolumic superabsorbent is sodium or potassium polyacrylate.

4. The method of claim 1, wherein said laboratory waste contains acetone or ethanol or both.

5. The method of claim 1, wherein said laboratory waste is contaminated with a water-miscible organic solvent, a metal, a radioactive isotope, or a combination thereof.

6. The method of claim 1, further comprising incinerating said film-type inner container and solidified laboratory waste in an approved incinerator.

7. The method of claim 1, further comprising disposing of said film-type inner container and solid waste in an approved solid waste landfill.

8. The method of claim 1, wherein said solidified waste satisfies regulatory requirements for transport and disposal as solid waste.

9. The method of claim 1, wherein said film-type container has a capacity of 0.5 to 4 liters.

10. A kit for converting aqueous liquid laboratory waste to solidified waste, comprising
at least 10 film-type inner containers of a size designed to be suitable for use in a pre-defined outer rigid container; and
a sealed container of isovolumic superabsorbent sufficient for at least 10 of said film-type inner containers.

11. The kit of claim 10, comprising at least 20 of said film-type inner containers.

12. The kit of claim 10, wherein said film-type inner containers each has a capacity of 0.5 to 4 liters.

13. The kit of claim 10, further comprising a scoop having a volume of about 10 to 20 cm³.
